(19) United States
(12) Patent Application Publication
(10) Pub. No.: US 2025/0348405 A1
(43) Pub. Date: Nov. 13, 2025

(54) REDUCING THE AMOUNT OF ANOMALY DETECTION NOISE IN A DISTRIBUTED COMPUTING ENVIRONMENT

(71) Applicant: MICROSOFT TECHNOLOGY LICENSING, LLC, Redmond, WA (US)

(72) Inventors: Yingnong DANG, Sammamish, WA (US); Vincent Joseph BLAS, Edmonds, WA (US); John Bronn SOCHA-LEIALOHA, Bellevue, WA (US); Tomi RATY, Kirkland, WA (US); Hrishikesh Devadatta KULKARNI, Washington, DC (US)

(21) Appl. No.: 18/660,592

(22) Filed: May 10, 2024

(51) Int. Cl. G06F 11/34

(52) U.S. Cl. CPC G06F 11/3495

(57) ABSTRACT

The techniques described herein reduce the noise when making a health determination for an entity executing within, or supported by, a distributed computing environment. The system is configured to receive health data corresponding to resources upon which the entity depends. The health data can include an indication of whether an individual resource is healthy or unhealthy (e.g., based on values collected for metrics). The system uses hysteresis to reduce the noise when making a health determination for the entity. That is, the system calculates a historic center value (e.g., a historic average value) and a spread value (e.g., standard deviation) for the history center value, and uses the spread value to establish different thresholds for health state transitions.

### BACKGROUND

A cloud platform such as MICROSOFT AZURE, AMAZON WEB SERVICES, GOOGLE CLOUD, etc. is configured to provide resources for various tenants. A tenant may be a customer, a business, an organization, a client, an individual user, and so forth. The datacenters and other infrastructure that comprise the cloud platform are constructed with a variety of different types of “cloud” resources (e.g., processing resources, storage resources, networking resources, power resources, temperature control resources) which work together to execute tenant services (e.g., an application) and/or cloud resource provider services that support and enable execution of the tenant services (e.g., a cloud resource provider is tasked with managing an orchestration and deployment service such as KUBERNETES).

Existing health monitoring systems monitor the health of individual cloud resources based on collected values for various metrics specifically collected with respect to the individual cloud resource. An individual cloud resource is an identifiable unit that can be dynamically associated with (e.g., allocated) and disassociated from (e.g., deallocated) the execution of a service. For instance, an individual cloud resource can include a virtual machine, a storage unit (e.g., an SQL database), a container, a physical server, a network switch, a container registry, a key vault instance, a micro-service of a tenant application, and so forth. Consequently, an individual cloud resource can be a logical unit, a physical unit, or a combination of both. It follows that the various metrics for which values are collected and monitored can include but are not limited to central process unit usage and/or capacity, memory usage and/or capacity, temperature of a hardware element, queue length, latency (e.g., a measure of how long it takes to return a response to a request), error rate (e.g., a number of requests that encounter an error compared to a total number of requests processed), throughput (e.g., a measure of requests handled per second), durability (e.g., a measure that tracks the resiliency and ability to maintain data integrity over time), and so forth.

The values collected for the various metrics are used to determine whether a cloud resource in healthy or unhealthy. If an individual cloud resource is determined to be unhealthy, then existing health monitoring systems determine that the individual cloud resource may be operating in an anomalous manner. Stated alternatively, existing health monitoring systems are said to have made an “anomaly detection” with respect to a cloud resource.

The anomaly detections of individual cloud resources associated with a service are then used to determine a value related to the health of the service over time. More specifically, existing health monitoring systems typically use a model to set an upper threshold and a lower threshold that define a “normal” range for the value related to the health of the service. Thus, if the value is within the normal range (i.e., between the lower threshold and upper threshold), then the service is determined to be healthy. If the value is outside the normal range (i.e., above the upper threshold or below the lower threshold), then the service is determined to be unhealthy.

### SUMMARY

The system described herein implements techniques for reducing the noise when making a health determination for an entity executing within, or supported by, a distributed computing environment (e.g., one or more cloud platforms, one or more edge networks, one or more on-premises networks, or a combination thereof). As used herein, an entity is an identifiable logical and/or physical unit in the distributed computing environment. For example, the entity can include a service, an application, a geographic region, a datacenter or group of datacenters, a server farm or group of server farms, and so forth. An entity can be owned by a tenant or a resource provider (e.g., an orchestration system).

Operation of an entity is dependent upon various resources in the distributed computing environment. An individual resource can include a processor, a storage device, a physical network port, a virtual machine, a storage unit (e.g., an SQL database), a container, a physical server, a network switch, a container registry, a key vault instance, a micro-service of a tenant application, and so forth. Furthermore, an individual resource can include a group of resources (e.g., a group of the resources mentioned in the previous sentence). An individual resource can be a logical resource, a physical resource, or a combination of both.

The system described herein is configured to receive health data corresponding to the resources upon which the entity depends. The health data can include an indication of whether an individual resource is healthy or unhealthy (e.g., based on values collected for metrics). The system uses hysteresis to reduce the noise when making a health determination for the entity. Using hysteresis enables the provision of efficient indications and avoids latency, which is often introduced via the use of other noise reducing approaches which requires the calculation of a rolling average for real-time use (e.g., the use of a low-pass filter).

Accordingly, the health data received by the system includes historic health data for the resources over a previous period of time. In one example, the previous period of time is a sliding predefined recent time window (e.g., the most recent hour, the most recent day, the most recent week, the most recent month, the most recent forty-five days, the most recent year). In another example, the previous period of time reflects a periodic time unit to account for seasonality (e.g., the same hour in a day, the same week in a month, the same month in a year). In yet another example, the previous period of time is a sliding predefined recent time window adjusted using the periodic time unit to account for seasonality. The health data received by the system also includes current health data, or a current value, for the resources which is continually received in present time (e.g., every second, every ten seconds, every minute, every ten minutes, every hour). In many contexts, the current health data may be referred to as “real-time”health data. Using the sliding predefined recent time window example, the current health data becomes historic health data as time progresses.

The system is configured to calculate a historic center value (e.g., a historic average value, a historic median value) using the historic health data for the resources over the previous period of time. The historic center value indicates the overall health of the resources upon which the entity depends. In one example, the historic center value is a historic center ratio established based on a number of unhealthy resources upon which the entity depends and a number of total resources upon which the entity depends. The number of total resources upon which the entity depends may be limited to resources that are actively being used (e.g., in operation) by the entity at a given time. In another example, the historic center value comprises a center absolute number (e.g., a positive integer number) of unhealthy resources (e.g., a count) upon which the entity depends regardless of the number of total resources upon which the entity depends.

Furthermore, using the historic health data, the system calculates a spread value for the historic center value. In one example, the spread value is the standard deviation. The standard deviation is the square root of the variance of the historic center value, and is commonly referred to as sigma, or “σ”. For example, the system first calculates the mean of the sampled historic values. The historic values can be sampled in accordance with a sampling rate (e.g., every minute, every ten minutes, every hour). Next, the system calculates the deviation of each sampled historic value from the mean, and squares the result. The variance is the mean of the squared results and, as mentioned above, the standard deviation is equal to the square root of the variance.

The system uses the spread vale for the historic center value to establish thresholds which reduce the noise when making a health determination for the entity. As described herein, the thresholds are associated with health state transitions and the thresholds are different. That is, the system establishes a first threshold based on a first multiple of the spread value (e.g., “1σ”, “1.5σ”, “2σ”, “3σ”). When the current value, as received by the system in present time, crosses the first threshold, the system generates an indication of a transition for the entity from a first health state (e.g., a healthy state) to a second health state (e.g., an unhealthy state).

The system also establishes a second threshold based on a second multiple of the spread value (e.g., “0.5σ”, “1σ”, “1.5σ”, “2σ”). When the current value, as received by the system in present time, crosses the second threshold, the system generates an indication of a transition for the entity from the second health state back to the first health state. The current value is moving in one direction (e.g., the value is increasing over time) when crossing the first threshold and the current value is moving in the opposite direction (e.g., the value is decreasing over time) when crossing the second threshold.

In the example where the current value is increasing when crossing the first threshold and decreasing when crossing the second threshold, the second threshold is established to be significantly lower than the first threshold. Significant in this context reflects an amount large enough to remove the noise described above. In this example, the first threshold may be referred to, via hysteresis, as the “on” threshold and the second threshold may be referred to, via hysteresis, as the “off” threshold. The offsetting thresholds allow the current value to move slightly above and below either of the on or off thresholds without the health state changing, which thereby reduces the noise associated with insignificant changes. Using the example of healthy and unhealthy states, the entity is not determined to be in the unhealthy state until the current value exceeds the upper on threshold and the entity is not determined to have returned to the healthy state until the current value drops below the associated lower off threshold.

As mentioned above, the system is configured to provide indications of the health state transitions. For example, the system can provide the indications to an owner of the entity or to another party interested in the health state of the entity. In various examples, an indication includes real-world timing information associated with a health state transition. For instance, the real-world timing information can reflect an exact time (e.g., month, day, time of day) when the current value crosses a threshold. Alternatively, the real-world timing information can reflect a time when the current value started moving toward a threshold.

In various examples, the first threshold and the second threshold discussed above are established based on a sensitivity input from an owner of the entity. This enables the system to satisfy varying entity owner perspectives on health. For example, an owner of one entity may use a large number of standard deviations (e.g., “4σ”) for the on threshold because the owner does not want, or need, the health state transitions to be sensitive. In contrast, another owner of another entity may use a small number of standard deviations (e.g., “1σ”) for the on threshold because the owner wants, or needs, the health state transitions to be sensitive. Consequently, the system described herein is adaptable in order to account for a specific entity owner's perspective of what makes an entity healthy or unhealthy.

An additional challenge related to noise presents itself when determinations are made for “small” entities. A small entity is one where the total number of resources upon which the small entity depends is less than a minimum threshold number of resources (e.g., ten, twenty, one hundred). In this type of scenario, the historic center value and the spread value are often small (e.g., significantly less than one). Consequently, a change in the health of a single resource can indicate a significant health change transition for the small entity. However, a single resource being unhealthy is not uncommon, and thus, is not significant. Accordingly, in scenarios where the total number of resources upon which an entity depends is less than the minimum threshold number of resources, the system is configured to use predefined values (e.g., based on a minimum standard deviation) to establish the first threshold and second threshold instead of the calculated spread value. The predefined value for the on threshold is a positive integer number that is greater than one. In this way, a small entity that depends on ten resources can have one resource fail, or be unhealthy, without causing a health state transition.

As further described below, the technical benefits of the techniques described herein are able to conserve resources related to health state transition notifications by using hysteresis to reduce the noise when making a health determination for an entity. Moreover, the use of hysteresis enables the provision of efficient indications and avoids latency, which is often introduced via the use of other noise reducing approaches which requires the calculation of a rolling average for real-time use (e.g., the use of a low-pass filter).

This Summary is provided to introduce a selection of concepts in a simplified form that are further described blow in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 illustrates an example environment in which a system reduces the noise when making a health determination for an entity executing within, or supported by, a distributed computing environment.

FIG. 2 illustrates a timing diagram that separates health data for a first period of time, which is useable to calculate a historic center value (e.g., historic average value) and spread value (e.g., standard deviation), from health data for a second period of time, which continually produces a current value representative of the present time health of the entity.

FIG. 3 illustrates a line graph that reflects how hysteresis is used to establish the thresholds, e.g., an “on” threshold and an “off” threshold, that can reduce the noise associated with health state determinations for the entity.

FIG. 4 is a flowchart depicting an example process for reducing the noise when making a health determination for the entity executing within, or supported by, the distributed computing environment.

FIG. 5 is an example computing system in accordance with the present disclosure.

### DETAILED DESCRIPTION

The modeling approach of setting upper and lower thresholds for values used to monitor health of a service can produce noisy results when a value is fluctuating close to either the upper threshold or the lower threshold for a period of time. More specifically, the noise results when the value moves slightly below a threshold and then slightly above the threshold (or vice versa), and this cycle continues for the period of time. In this type of scenario, existing health monitoring systems determine that the service is frequently experiencing significant health changes (e.g., switching back and forth between healthy and unhealthy) even though the fluctuating value is more or less stable (e.g., changing by an insignificant amount). Consequently, the normal range for the value used by existing health monitoring systems to determine the health of the service are capable of producing noisy results, e.g., providing indications of significant service health changes when in reality the service health changes are insignificant.

The system described herein implements techniques for reducing the noise when making a health determination for an entity executing within, or supported by, a distributed computing environment. The system is configured to receive health data corresponding to the resources upon which the entity depends. The health data can include an indication of whether an individual resource is healthy or unhealthy (e.g., based on values collected for metrics). The system uses hysteresis to reduce the noise when making a health determination for the entity. That is, the system calculates a historic center value (e.g., historic average value) and a spread value (e.g., a standard deviation) for the history center value, and uses the spread value to establish different thresholds for health state transitions.

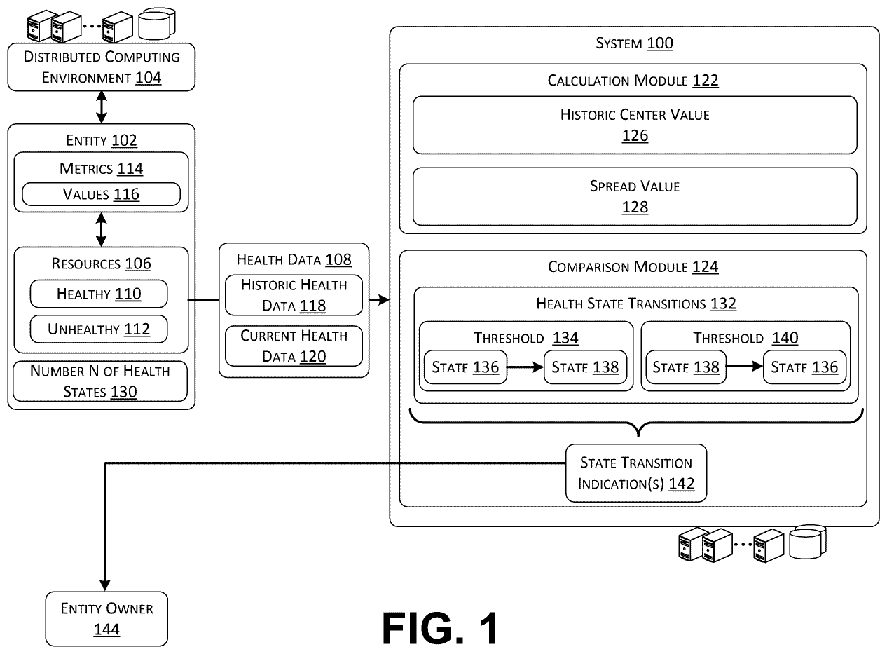

FIG. 1 illustrates an example environment in which a system 100 implements techniques for reducing the noise when making a health determination for an entity 102 executing within, or supported by, a distributed computing environment 104 (e.g., one or more cloud platforms, one or more edge networks, one or more on-premises networks, or a combination thereof). In various examples, the system 100 can be part of the distributed computing environment 104.

An entity 102 is an identifiable logical and/or physical unit in the distributed computing environment 104. For example, the entity 102 can include a service, an application, a geographic region, a datacenter or group of datacenters, a server farm or group of server farms, and other units having monitorable health and performance metrics. An entity can be owned by a tenant or a resource provider (e.g., an orchestration system). Execution of the entity 102 is dependent upon various types of resources 106. A type of resource 106 can include a processor, a storage device, a physical network port, a virtual machine, a storage unit (e.g., an SQL database), a container, a physical server, a network switch, a container registry, a key vault instance, a micro-service of a tenant application, and so forth. Furthermore, an individual resource can include a group of resources (e.g., a group of the resources mentioned in the previous sentence). An individual resource 106 can be a logical resource, a physical resource, or a combination of both.

As shown, the system 100 is configured to receive health data 108 corresponding to the resources 106 upon which the entity 102 depends. The health data 108 can include an indication of whether an individual resource 106 is healthy 110 or unhealthy 112. For example, an individual resource 106 can be associated with various metrics 114 for which values 116 are collected and analyzed. A resource health determination algorithm can be applied to an aggregation of the values 116 in order to categorize an individual resource 106 as healthy 110 or unhealthy 112. While FIG. 1 illustrates that the system 100 is separate from the entity 102 and the health data 108, it is understood in the context of this disclosure that the system 100 can alternatively include the entity 102 and/or the health data 108 (e.g., the system 100 can produce the values 116 and/or categorize an individual resource 106 as healthy 110 or unhealthy 112).

In various examples, the resource health determination algorithm can be specific to a type of resource. In one example, the resource health determination algorithm determines whether a value 116 for a specific metric 114 is above or below a threshold value established to indicate a healthy scenario or an unhealthy scenario for the corresponding resource 106. The resource health determination algorithm can be continuously applied in real-time, in accordance with a predefined schedule (e.g., on values 116 collected every minute, every ten minutes, every thirty minutes), or on-demand. The resource health determination algorithm can be a dynamic algorithm that implements time-based adjustments to a range of accepted or expected values 116 for a metric 114 by learning a higher threshold value to define the top of a range and a lower threshold value to define the bottom of the range. Alternatively, the resource health determination algorithm can use static thresholds to define the top and the bottom of the range.

Accordingly, the threshold values used in the resource health determination algorithm are established for individual metrics 114. The resource health determination algorithm can be configured to apply weighted parameters to the individual metrics 114 in order to identify scenarios where the metrics 114, as an aggregate, indicate that an associated resource 106 is healthy 110 or unhealthy 112. Stated alternatively, the resource health determination algorithm is configured to determine when the collected values 116, considered as an aggregate across a plurality of metrics 114, indicate that the performance of the associated resource 106 is being severely impacted in a negative manner. In various examples, the resource health determination algorithm calculates a normalized health score for the resource 106 such that the output is a value between zero and one. The categorization of the resource 106 as healthy 110 or unhealthy 112 can be based on a threshold implemented with respect to the range of the normalized health score. For example, a normalized health score below “0.70” (i.e., 70%) amounts to an unhealthy 112 categorization for the resource 106 while a normalized health score at or above “0.70” amounts to a healthy 110 categorization for the resource 106.

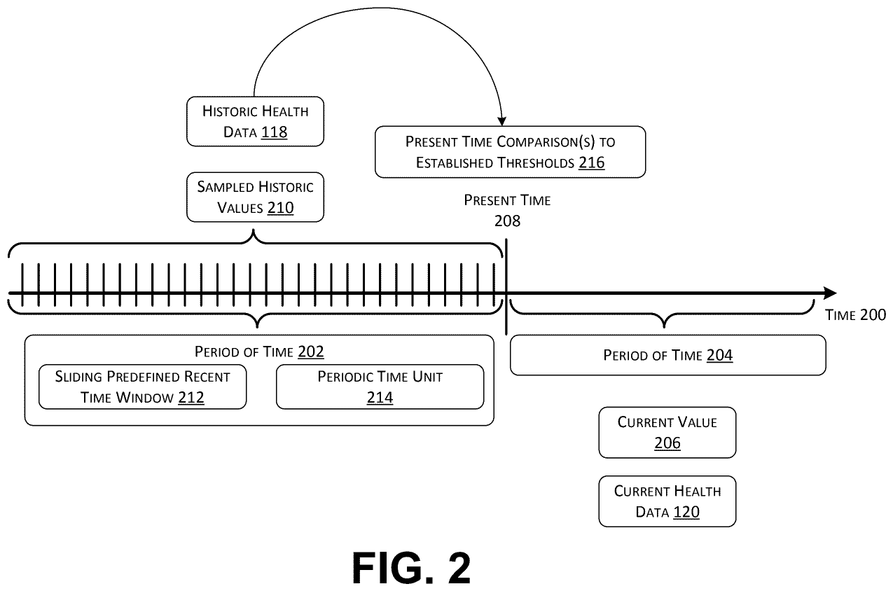

The health data 108 received by the system 100 includes historic health data 118 for the resources 106 which reflects the health for a previous period of time, as further discussed herein with respect to FIG. 2. The health data 108 received by the system 100 further includes current health data 120 for the resources 106 which is continually received in present time (e.g., every second, every ten seconds, every minute, every ten minutes, every hour). In many contexts, the current health data 120 may be referred to as “real-time” health data.

The system 100 includes a calculation module 122 and a comparison module 124, each of which is discussed in more detail below. The number of modules illustrated in FIG. 1 is just an example, and the number can vary. That is, functionality described herein in association with the illustrated modules can be performed by a fewer number of modules or a larger number of modules on one device in the system 100 or spread across multiple devices in the system 100.

The calculation module 122 is configured to calculate a historic center value 126 (e.g., a historic average value, historic median value) using the historic health data 118 for the resources 106. The historic center value 126 indicates the overall health of the resources 106 upon which the entity 102 depends. Furthermore, using the historic health data 118, the calculation module 122 calculates a spread value 128 for the historic center value 126. In one example, the spread value 128 is the standard deviation, which is the square root of the variance of the historic center value 126, and is commonly referred to as sigma, or “o”.

The comparison module 124 uses the spread value 128 for the historic center value 126 to establish thresholds which reduce the noise when making a health determination for the entity 102. Using hysteresis, two different thresholds are established for the two transitions between each pair of health states. As shown in FIG. 1, the entity 102 can be associated with a number N of health states 130 (where N is equal to two or more health states). The comparison module 124 determines health state transitions 132 between each pair of health states in the number N of health states 130, and accordingly, generates a first threshold 134 for the transition from a first health state 136 into a second health state 138. Similarly, the comparison module 124 generates a second threshold 140 for the transition from the second health state 138 back to the first health state 136. Consequently, if the number N of health states 130 is two (e.g., N=2 and the health states are a healthy state and an unhealthy state), then the first threshold 134 is established for a transition from the healthy state to the unhealthy state and the second threshold 140 is established for a transition from the unhealthy state back to the healthy state. Accordingly, the aforementioned first and second thresholds are essentially substitutes for only one of the upper threshold or the lower threshold that together define the normal range, not both.

However, the comparison module 124 is configured to generate additional thresholds for additional health state transitions 132. For example, if the number N of health states 130 is three (e.g., N=3 and the health states reflect a sequential deteriorating and/or improving scenario reflected by a healthy state, a degraded state, and an unhealthy state), then one set of thresholds 134, 140 is established for the transitions from the healthy state to the degraded state and from the degraded state back to the healthy state. Furthermore, another set of thresholds 134, 140 are established for transitions from the degraded state to the unhealthy state and for the unhealthy state back to the degraded state. There is no limit to the number N of health states 130.

As mentioned above, the thresholds 134, 140 associated with health state transitions 132 between a pair of health states are different. That is, the comparison module 124 establishes the first threshold 134 based on a first multiple of the spread value 128 (e.g., “1σ”, “1.5σ”, “2σ”, “3σ”). The comparison module 124 establishes the second threshold 140 based on a second multiple of the spread value 128 (e.g., “0.5σ”, “1σ”, “1.5σ”, “2σ”).

When the current value, which is received by the system 100 in present time via the current health data 120, crosses the first threshold 134, the comparison module 124 generates an indication 142 of a transition for the entity 102 from the first health state 136 (e.g., a healthy state) to the second health state 138 (e.g., an unhealthy state). The current value is moving in one direction (e.g., the value is increasing over time or the value is decreasing over time) when crossing the first threshold 134 and the current value is moving in the opposite direction (e.g., the value is decreasing over time or the value is increasing over time) when crossing the second threshold 140. Accordingly, when the current value crosses the second threshold 140, the comparison module 124 similarly generates an indication 142 of a transition for the entity 102 from the second health state 138 (e.g., the unhealthy state) back to the first health state 136 (e.g., the healthy state).

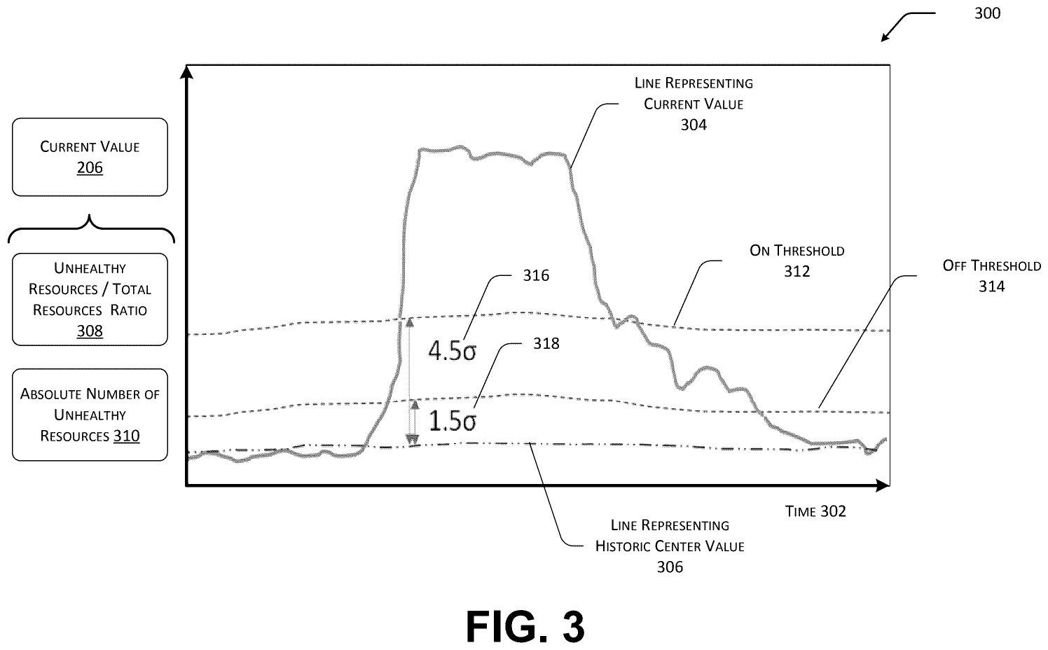

As further described below with respect to FIG. 3, in the example where the current value is increasing when crossing the first threshold 134 and decreasing when crossing the second threshold 140, the second threshold 140 is established to be significantly lower than the first threshold 134. Significant in this context reflects an amount large enough to reduce or remove the noise described above. The first threshold 134 may be referred to, via hysteresis, as the “on” threshold and the second threshold 140 may be referred to, via hysteresis, as the “off” threshold. The offsetting thresholds 134, 140 allow the current value to move slightly above and below either of the on or off thresholds without the health state of the entity 102 changing, thereby reducing the noise associated with insignificant changes. Using the example of healthy and unhealthy states, the entity 102 is not determined to be in the unhealthy state until the current value exceeds the upper on threshold (e.g., the first threshold 134) and the entity 102 is not determined to have returned to the healthy state until the current value drops below the associated lower off threshold (e.g., the second threshold 140).

The system 100 is configured to provide the indications 142 of the health state transitions for the entity 102. For example, the system 100 can provide the indications 142 to an owner 144 of the entity 102 or to another party interested in the health state and/or the health state transitions 132 associated with the entity 102. In various examples, an indication 142 includes real-world timing information associated with a health state transition 132. For instance, the real-world timing information can reflect an exact time (e.g., month, day, time of day) when the current value crosses a threshold 134 or 140. Alternatively, the real-world timing information can reflect a time when the current value started moving toward a threshold 134 or 140 (e.g., the current value reaches a predefined value distance of a threshold).

Consequently, the techniques described herein are able to conserve resources by using hysteresis to reduce the noise when making a health determination for an entity 102, as the number of health state transition indications 142 that need to be issued are reduced. Moreover, the use of hysteresis in this context enables the provision of efficient health state transition indications 142 (e.g., limited latency), which is important to many entity owners 144 (e.g., tenants, resource providers). Typical noise reducing approaches (e.g., the use of a low-pass filter) introduce an unwanted degree of latency because they require the calculation of a rolling average for real-time use.

FIG. 2 illustrates a timing diagram with a time axis 200 that separates the historic health data 118 for a first period of time 202, which is useable to calculate the historic center value 126 and spread value 128, from health data for a second period of time 204, which continually produces a current value 206 which is provided to the system as the current health data 120 based on a present time 208.

The historic health data 118 includes historic values 210 that are sampled in accordance with a sampling rate (e.g., every minute, every ten minutes, every hour). The calculation module 122 first calculates a center for the sampled historic values 210 (e.g., a historic average value). In various examples, the comparison module 124 then calculates the deviation of each sampled historic value 210 from the center, and squares the result. The variance is the mean of the squared results and, as mentioned above, the standard deviation is equal to the square root of the variance.

In one example, the first period of time 202 is a sliding predefined recent time window 212 (e.g., the most recent hour, the most recent day, the most recent week, the most recent month, the most recent forty-five days, the most recent year). In another example, the first period of time 202 reflects a periodic time unit 214 to account for seasonality (e.g., the same hour in a day, the same week in a month, the same month in a year). In yet another example, the previous period of time is a sliding predefined recent time window adjusted using the periodic time unit to account for seasonality. Using the sliding predefined recent time window 212 example, current health data 120 becomes historic health data 118 as time 200 progresses. In FIG. 2, the current value 206 is associated with the present time 208, and the current value 206 is continually received by the system 100 during the second period of time 204 as the time 200 progresses. The current value 206 enables present time comparisons 216 to the thresholds 134, 140 established based on the historic center value 126 and the spread value 128.

FIG. 3 illustrates a line graph 300 that reflects how hysteresis is used to establish the thresholds, e.g., an on threshold and an off threshold, that can reduce the noise associated with health state determinations for an entity. The x-axis in the line graph 300 represents time 302 and the y-axis represents the current value 206, as depicted by line 304, received by the system 100 over the period of time represented by the x-axis (e.g., period of time 204).

The line graph 300 further includes a dashed line 306 that represents the historic center value 126. In one example, the historic center value 126 and the current value 206 are a ratio 308 established based on a number of unhealthy resources upon which the entity 102 depends and a number of total resources upon which the entity 102 depends. The number of total resources 106 upon which the entity 102 depends may be limited to resources 106 that are actively being used (e.g., in operation) by the entity 102 at a given time. In another example, the historic center value 126 and the current value 206 are an absolute number (e.g., a positive integer number) of unhealthy resources 310 upon which the entity depends regardless of the number of total resources on which the entity 102 depends.

As described in the examples above, the first threshold 134 can be referred to as the on threshold, which is represented by the dashed line 312. Moreover, the second threshold 140 can be referred to as the off threshold, which is represented by the dashed line 314. In the example of FIG. 3, the on threshold is established using “4.5σ”, as referenced by 316, and the off threshold is established using “1.5σ”, as referenced by 318. Thus, the health of the entity is determined to transition from the first health state 136 (e.g., a healthy state) to a second health state 138 (e.g., an unhealthy state) when the current value increases an amount that crosses the on threshold 312. However, the health of the entity is not determined to transition from the second health state 138 back to the first health state 136 when the current value decreases to cross the on threshold 312. Instead, the health of the entity is determined to transition from the second health state 138 back to the first health state 136 when the current value decreases to cross the off threshold 314, which is significantly lower than the on threshold 312. This enables the noise reduction described above, as the current value is allowed to insignificantly fluctuate around the on threshold 312 without triggering a significant health state transition.

The techniques described with respect to the line graph 300 replace a dynamic or static upper threshold used to establish a range of acceptable, or expected, current values. Similar techniques can be used to replace a dynamic or static lower threshold used to establish the range of acceptable, or expected, current values. That is, an on threshold is also useable to trigger a state transition when the current value is decreasing and an off threshold is also useable to trigger a return state transition when the current value is increasing. In this context, the off threshold is a “higher” value than the off threshold.

In various examples, the first threshold 134 and the second threshold 140 are established based on a sensitivity input from the owner 144 of the entity 102. This enables the system 100 to satisfy varying entity owner perspectives on health. For example, an owner of the entity for which the current values are reflected in FIG. 3 uses a large number of standard deviations (e.g., “4.5σ” 316) for the on threshold 312 because the owner does not want, or need, the health state transitions to be sensitive. In contrast, another owner of another similar entity may use a small number of standard deviations (e.g., “1σ”) for the on threshold because the owner wants, or needs, the health state transitions to be sensitive. Consequently, the system 100 described herein is adaptable in order to account for a specific entity owner's perspective of what makes an entity healthy, unhealthy, or other defined health states.

An additional challenge related to noise presents itself when determinations are made for “small” entities. A small entity is one where the total number of resources upon which the small entity depends is less than a minimum threshold number of resources (e.g., ten, twenty, one hundred). In this type of scenario, the historic enter value and the spread value (e.g., standard deviation) are often small (e.g., significantly less than one). Consequently, a change in the health of a single resource can indicate a significant health change transition for the small entity. However, a single resource being unhealthy is not uncommon, and thus, is not significant. Accordingly, in scenarios where the total number of resources upon which an entity depends is less than the minimum threshold number of resources, the system is configured to use predefined values (e.g., based on a minimum standard deviation) to establish the first threshold and second threshold instead of the calculated spread value. The predefined value for the on threshold is a positive integer number that is greater than one. In this way, a small entity that depends on ten resources can have one resource fail, or be unhealthy, without causing a health state transition.

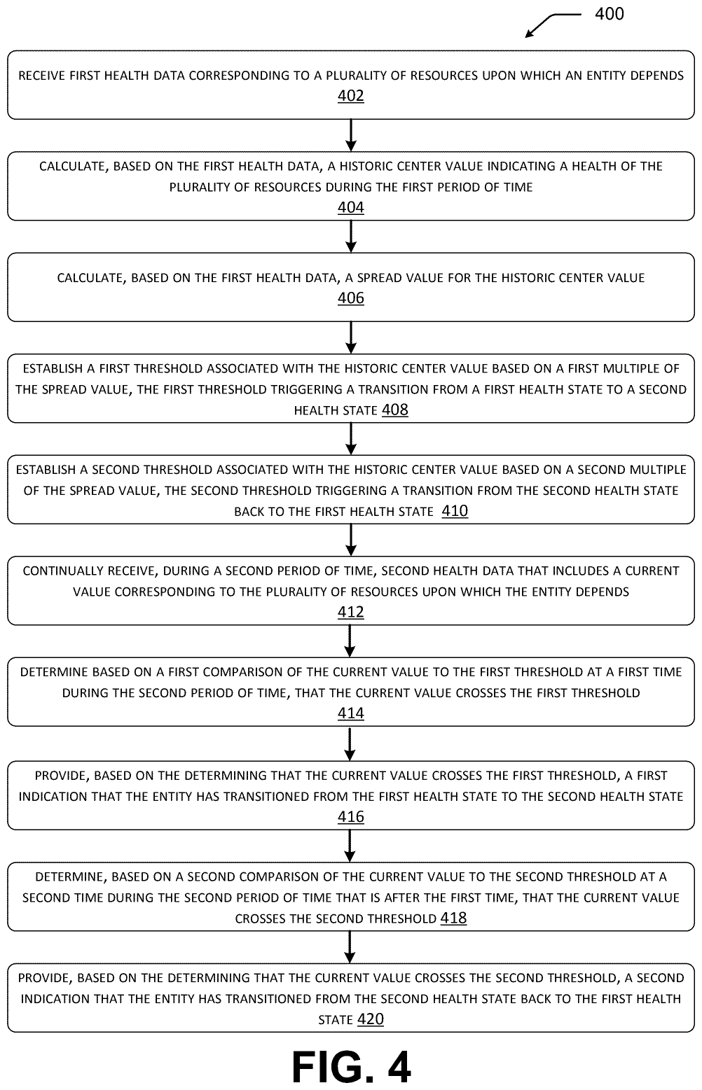

Proceeding to FIG. 4, aspects of a process 400 for reducing the noise when making a health determination for an entity executing within, or supported by, a distributed computing environment are shown and described. The process 400 begins at operation 402 where a system receives, during a first period of time, first health data corresponding to a plurality of resources upon which the entity depends. The first health data includes historic values established based on whether a resource, of the plurality of resources, upon which the entity depends is healthy or unhealthy at a given time during the first period of time.

At operation 404, the system calculates, based on the first health data, a historic center value (e.g., a historic average value) indicating a health of the plurality of resources during the first period of time.

At operation 406, the system calculates, based on the first health data, a spread value (e.g., standard deviation) for the historic center value.

At operation 408, the system establishes a first threshold associated with the historic center value based on a first multiple of the spread value. As described above, the first threshold triggers a transition for the entity from a first health state to a second health state.

At operation 410, the system establishes a second threshold associated with the historic center value based on a second multiple of the spread value. As described above, the second threshold triggers a transition for the entity from the second health state back to the first health state.

At operation 412, the system continually receives, during a second period of time, second health data corresponding to the plurality of resources upon which the entity depends. The second health data includes a current value established based on whether the resource, of the plurality of resources, upon which the entity depends is healthy or unhealthy at a present time during the second period of time.

At operation 414, the system determines, based on a first comparison of the current value to the first threshold at a first time during the second period of time, that the current value crosses the first threshold.

At operation 416, the system provides, based on the determining that the current value crosses the first threshold, a first indication that the entity has transitioned from the first health state to the second health state.

At operation 418, the system determines, based on a second comparison of the current value to the second threshold at a second time during the second period of time that is after the first time, that the current value crosses the second threshold.

At operation 420, the system provides, based on the determining that the current value crosses the second threshold, a second indication that the entity has transitioned from the second health state back to the first health state.

For ease of understanding, the process discussed in this disclosure is delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 400 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 400 may also be implemented in other ways. In addition, one or more of the operations of the process 400 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

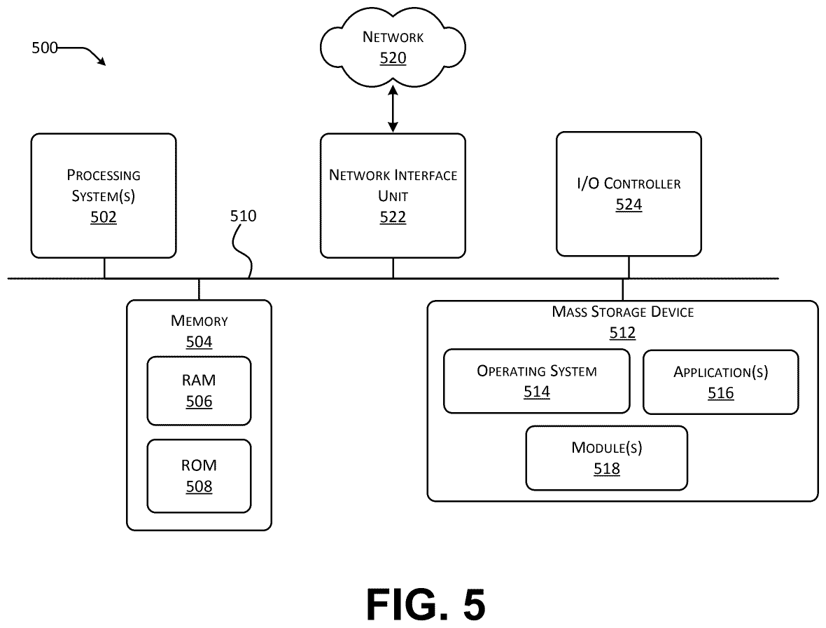

FIG. 5 shows additional details of an example computer architecture 500 for a device, such as a computer or a server configured as part of the system 100, capable of executing computer instructions (e.g., a module described herein). The computer architecture 500 illustrated in FIG. 5 includes processing system 502, a system memory 504, including a random-access memory 506 (RAM) and a read-only memory (ROM) 508, and a system bus 510 that couples the memory 504 to the processing system 502. The processing system 502 comprises processing unit(s). In various examples, the processing unit(s) of the processing system 502 are distributed. Stated another way, one processing unit of the processing system 502 may be located in a first location (e.g., a rack within a datacenter) while another processing unit of the processing system 502 is located in a second location separate from the first location.

Processing unit(s), such as processing unit(s) of processing system 502, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 500, such as during startup, is stored in the ROM 508. The computer architecture 500 further includes a mass storage device 512 for storing an operating system 514, application(s) 516, modules 518, and other data described herein.

The mass storage device 512 is connected to processing system 502 through a mass storage controller connected to the bus 510. The mass storage device 512 and its associated computer-readable media provide non-volatile storage for the computer architecture 500. Although the description of computer-readable media contained herein refers to a mass storage device, the computer-readable media can be any available computer-readable storage media or communication media that can be accessed by the computer architecture 500.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 500 may operate in a networked environment using logical connections to remote computers through the network 520. The computer architecture 500 may connect to the network 520 through a network interface unit 522 connected to the bus 510. The computer architecture 500 also may include an input/output controller 524 for receiving and processing input from a number of other devices, including a keyboard, mouse, touch, or electronic stylus or pen. Similarly, the input/output controller 524 may provide output to a display screen, a printer, or other type of output device.

The software components described herein may, when loaded into the processing system 502 and executed, transform the processing system 502 and the overall computer architecture 500 from a general-purpose computing system into a special-purpose computing system customized to facilitate the functionality presented herein. The processing system 502 may be constructed from any number of transistors or other discrete circuit elements, which may individually or collectively assume any number of states. More specifically, the processing system 502 may operate as a finite-state machine, in response to executable instructions contained within the software modules disclosed herein. These computer-executable instructions may transform the processing system 502 by specifying how the processing system 502 transition between states, thereby transforming the transistors or other discrete hardware elements constituting the processing system 502.

The disclosure presented herein also encompasses the subject matter set forth in the following clauses.

Example Clause A, a method for reducing noise in health determination for an entity executing via a distributed computing environment, comprising: receiving first health data corresponding to a plurality of resources upon which the entity depends, wherein the first health data includes historic values established based on whether a resource, of the plurality of resources, is healthy or unhealthy at a given time during a first period of time; calculating, based on the first health data, a historic center value indicating a health of the plurality of resources during the first period of time; calculating, based on the first health data, a spread value for the historic center value; establishing a first threshold associated with the historic center value based on a first multiple of the spread value, wherein the first threshold triggers a transition for the entity from a first health state to a second health state; establishing a second threshold associated with the historic center value based on a second multiple of the spread value, wherein the second threshold triggers a transition for the entity from the second health state back to the first health state; continually receiving, during a second period of time, second health data corresponding to the plurality of resources, wherein the second health data includes a current value established based on whether the resource, of the plurality of resources, is healthy or unhealthy at a present time during the second period of time; determining, based on a first comparison of the current value to the first threshold at a first time during the second period of time, that the current value crosses the first threshold; providing, based on the determining that the current value crosses the first threshold, a first indication that the entity has transitioned from the first health state to the second health state; responsive to determining that the current ratio crosses the first threshold, determining, based on a second comparison of the current value to the second threshold at a second time during the second period of time that is after the first time, that the current value crosses the second threshold; and providing, based on the determining that the current value crosses the second threshold, a second indication that the entity has transitioned from the second health state back to the first health state.

Example Clause B, the method of Example A, wherein the historic center value comprises a historic average ratio established based on a number of unhealthy resources and a number of total resources.

Example Clause C, the method of Example A, wherein the historic center value comprises an average absolute number of unhealthy resources.

Example Clause D, the method of any one of Examples A through C, wherein the first period of time comprises a sliding predefined recent time window.

Example Clause E, the method of any one of Examples A through C, wherein the first period of time reflects a periodic time unit to account for seasonality.

Example Clause F, the method of any one of Examples A through E, wherein the first threshold and the second threshold are established based on a sensitivity input from an owner of the entity.

Example Clause G, the method of any one of Examples A through F, wherein the first indication and the second indication include real-world timing information associated with a first transition from the first health state to the second health state and a second transition from the second health state back to the first health state.

Example Clause H, the method of any one of Examples A through G, wherein: a number of the plurality of resources is less than a threshold number of resources; and the method further comprises using predefined values to establish the first threshold and second threshold instead of the spread value, wherein the predefined values are set to address noise introduced when the number of the plurality of resources is less than the threshold number of resources.

Example Clause I, the method of any one of Examples A through H, further comprising: establishing a third threshold associated with the historic center value based on a third multiple of the spread value, wherein the third threshold triggers a transition for the entity from the second health state to a third health state; establishing a fourth threshold associated with the historic center value based on a fourth multiple of the spread value, wherein the fourth threshold triggers a transition for the entity from the third health state back to the second health state; determining, based on a third comparison of the current value to the third threshold at a third time between the first time and the second time, that the current value crosses the third threshold; providing, based on the determining that the current value crosses the third threshold, a third indication that the entity has transitioned from the second health state to the third health state; determining, based on a fourth comparison of the current value to the fourth threshold at a fourth time that is after the third time and before the second time, that the current value crosses the fourth threshold; and providing, based on the determining that the current value crosses the fourth threshold, a fourth indication that the entity has transitioned from the third health state back to the second health state.

Example Clause J, a system for reducing noise in health determination for an entity configured in a distributed computing environment, comprising: a processing system; and a computer readable storage medium storing instructions that, when executed by the processing system, cause the system to perform operations comprising: continually receiving, during a first period of time, a current value established based on whether a resource, of a plurality of resources, upon which the entity depends, is healthy or unhealthy at a present time during the first period of time; determining, at a first time during the first period of time and based on a first comparison of the current value to a first threshold that triggers a transition for the entity from a first health state to a second health state, that the current value crosses the first threshold, wherein the first threshold is established based on: a historic center value calculated based on historic values established based on whether the resource, of the plurality of resources is healthy or unhealthy at a sampled time during a second period of time before the first period of time; and a first multiple of a spread value for the historic center value; providing, based on the determining that the current value crosses the first threshold, a first indication that the entity has transitioned from the first health state to the second health state; determining, at a second time during the first period of time after the first time and based on a second comparison of the current value to a second threshold that triggers a transition for the entity from the second health state back to the first health state, that the current value crosses the second threshold, wherein the second threshold is established based on: the historic center value; and a second multiple of the spread value for the historic center value; and providing, based on the determining that the current value crosses the second threshold, a second indication that the entity has transitioned from the second health state back to the first health state.

Example Clause K, the system of Example Clause J, wherein the historic center value comprises a historic average ratio established based on a number of unhealthy resources and a number of total resources.

Example Clause L, the system of Example Clause J, wherein the historic center value comprises an average absolute number of unhealthy resources.

Example Clause M, the system of any one of Example Clauses J through L, wherein the second period of time comprises a sliding predefined recent time window.

Example Clause N, the system of any one of Example Clauses J through L, wherein the second period of time reflects a periodic time unit to account for seasonality.

Example Clause O, the system of any one of Example Clauses J through N, wherein the first threshold and the second threshold are established based on a sensitivity input from an owner of the entity.

Example Clause P, the system of any one of Example Clauses J through O, wherein the first indication and the second indication include real-world timing information associated with a first transition from the first health state to the second health state and a second transition from the second health state back to the first health state.

Example Clause Q, the system of any one of Example Clauses J through P, wherein: a number of the plurality of resources is less than a threshold number of resources; and the operations further comprise using predefined values to establish the first threshold and second threshold instead of the spread value, wherein the predefined values are set to address noise introduced when the number of the plurality of resources is less than the threshold number of resources.

Example Clause R, a method for reducing noise in health determination for an entity configured in a distributed computing environment, comprising: continually receiving, during a first period of time, a current value established based on whether a resource, of a plurality of resources, upon which the entity depends, is healthy or unhealthy at a present time during the first period of time; determining, at a first time during the first period of time and based on a first comparison of the current value to a first threshold that triggers a transition for the entity from a first health state to a second health state, that the current value crosses the first threshold, wherein the first threshold is established based on: a historic center value calculated based on historic values established based on whether the resource, of the plurality of resources is healthy or unhealthy at a sampled time during a second period of time before the first period of time; and a first multiple of a spread value for the historic center value; providing, based on the determining that the current value crosses the first threshold, a first indication that the entity has transitioned from the first health state to the second health state; responsive to determining that the current value crosses the first threshold, determining, at a second time during the first period of time after the first time and based on a second comparison of the current value to a second threshold that triggers a transition for the entity from the second health state back to the first health state, that the current value crosses the second threshold, wherein the second threshold is established based on: the historic center value; and a second multiple of the spread value for the historic center value; and providing, based on the determining that the current value crosses the second threshold, a second indication that the entity has transitioned from the second health state back to the first health state.

Example Clause S, the method of Example Clause R, wherein the historic center value comprises: a historic average ratio established based on a number of unhealthy resources and a number of total resources; or an average absolute number of unhealthy resources.

Example Clause T, the method of Example Clause R or Example Clause S, wherein the first threshold and the second threshold are established based on a sensitivity input from an owner of the entity.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for reducing noise in health determination for an entity executing via a distributed computing environment, comprising:
receiving first health data corresponding to a plurality of resources upon which the entity depends, wherein the first health data includes historic values established based on whether a resource, of the plurality of resources, is healthy or unhealthy at a given time during a first period of time;
calculating, based on the first health data, a historic center value indicating a health of the plurality of resources during the first period of time;
calculating, based on the first health data, a spread value for the historic center value;
establishing a first threshold associated with the historic center value based on a first multiple of the spread value, wherein the first threshold triggers a transition for the entity from a first health state to a second health state;
establishing a second threshold associated with the historic center value based on a second multiple of the spread value, wherein the second threshold triggers a transition for the entity from the second health state back to the first health state;
continually receiving, during a second period of time, second health data corresponding to the plurality of resources, wherein the second health data includes a current value established based on whether the resource, of the plurality of resources, is healthy or unhealthy at a present time during the second period of time;
determining, based on a first comparison of the current value to the first threshold at a first time during the second period of time, that the current value crosses the first threshold;
providing, based on the determining that the current value crosses the first threshold, a first indication that the entity has transitioned from the first health state to the second health state;
responsive to determining that the current ratio crosses the first threshold, determining, based on a second comparison of the current value to the second threshold at a second time during the second period of time that is after the first time, that the current value crosses the second threshold; and
providing, based on the determining that the current value crosses the second threshold, a second indication that the entity has transitioned from the second health state back to the first health state.

2. The method of claim 1, wherein the historic center value comprises a historic average ratio established based on a number of unhealthy resources and a number of total resources.

3. The method of claim 1, wherein the historic center value comprises an average absolute number of unhealthy resources.

4. The method of claim 1, wherein the first period of time comprises a sliding predefined recent time window.

5. The method of claim 1, wherein the first period of time reflects a periodic time unit to account for seasonality.

6. The method of claim 1, wherein the first threshold and the second threshold are established based on a sensitivity input from an owner of the entity.

7. The method of claim 1, wherein the first indication and the second indication include real-world timing information associated with a first transition from the first health state to the second health state and a second transition from the second health state back to the first health state.

8. The method of claim 1, wherein:
a number of the plurality of resources is less than a threshold number of resources; and
the method further comprises using predefined values to establish the first threshold and second threshold instead of the spread value, wherein the predefined values are set to address noise introduced when the number of the plurality of resources is less than the threshold number of resources.

9. The method of claim 1, further comprising:
establishing a third threshold associated with the historic center value based on a third multiple of the spread value, wherein the third threshold triggers a transition for the entity from the second health state to a third health state;
establishing a fourth threshold associated with the historic center value based on a fourth multiple of the spread value, wherein the fourth threshold triggers a transition for the entity from the third health state back to the second health state;
determining, based on a third comparison of the current value to the third threshold at a third time between the first time and the second time, that the current value crosses the third threshold;
providing, based on the determining that the current value crosses the third threshold, a third indication that the entity has transitioned from the second health state to the third health state;
determining, based on a fourth comparison of the current value to the fourth threshold at a fourth time that is after the third time and before the second time, that the current value crosses the fourth threshold; and
providing, based on the determining that the current value crosses the fourth threshold, a fourth indication that the entity has transitioned from the third health state back to the second health state.

10. A system for reducing noise in health determination for an entity configured in a distributed computing environment, comprising:
a processing system; and
a computer readable storage medium storing instructions that, when executed by the processing system, cause the system to perform operations comprising:
continually receiving, during a first period of time, a current value established based on whether a resource, of a plurality of resources, upon which the entity depends, is healthy or unhealthy at a present time during the first period of time;
determining, at a first time during the first period of time and based on a first comparison of the current value to a first threshold that triggers a transition for the entity from a first health state to a second health state, that the current value crosses the first threshold, wherein the first threshold is established based on:
a historic center value calculated based on historic values established based on whether the resource, of the plurality of resources is healthy or unhealthy at a sampled time during a second period of time before the first period of time; and
a first multiple of a spread value for the historic center value;
providing, based on the determining that the current value crosses the first threshold, a first indication that the entity has transitioned from the first health state to the second health state;
determining, at a second time during the first period of time after the first time and based on a second comparison of the current value to a second threshold that triggers a transition for the entity from the second health state back to the first health state, that the current value crosses the second threshold, wherein the second threshold is established based on:
the historic center value; and
a second multiple of the spread value for the historic center value; and
providing, based on the determining that the current value crosses the second threshold, a second indication that the entity has transitioned from the second health state back to the first health state.

11. The system of claim 10, wherein the historic center value comprises a historic average ratio established based on a number of unhealthy resources and a number of total resources.

12. The system of claim 10, wherein the historic center value comprises an average absolute number of unhealthy resources.

13. The system of claim 10, wherein the second period of time comprises a sliding predefined recent time window.

14. The system of claim 10, wherein the second period of time reflects a periodic time unit to account for seasonality.

15. The system of claim 10, wherein the first threshold and the second threshold are established based on a sensitivity input from an owner of the entity.

16. The system of claim 10, wherein the first indication and the second indication include real-world timing information associated with a first transition from the first health state to the second health state and a second transition from the second health state back to the first health state.

17. The system of claim 10, wherein:
a number of the plurality of resources is less than a threshold number of resources; and
the operations further comprise using predefined values to establish the first threshold and second threshold instead of the spread value, wherein the predefined values are set to address noise introduced when the number of the plurality of resources is less than the threshold number of resources.

18. A method for reducing noise in health determination for an entity configured in a distributed computing environment, comprising:
continually receiving, during a first period of time, a current value established based on whether a resource, of a plurality of resources, upon which the entity depends, is healthy or unhealthy at a present time during the first period of time;
determining, at a first time during the first period of time and based on a first comparison of the current value to a first threshold that triggers a transition for the entity from a first health state to a second health state, that the current value crosses the first threshold, wherein the first threshold is established based on:
a historic center value calculated based on historic values established based on whether the resource, of the plurality of resources is healthy or unhealthy at a sampled time during a second period of time before the first period of time; and
a first multiple of a spread value for the historic center value;
providing, based on the determining that the current value crosses the first threshold, a first indication that the entity has transitioned from the first health state to the second health state;
responsive to determining that the current value crosses the first threshold, determining, at a second time during the first period of time after the first time and based on a second comparison of the current value to a second threshold that triggers a transition for the entity from the second health state back to the first health state, that the current value crosses the second threshold, wherein the second threshold is established based on:
the historic center value; and
a second multiple of the spread value for the historic center value; and
providing, based on the determining that the current value crosses the second threshold, a second indication that the entity has transitioned from the second health state back to the first health state.

19. The method of claim 18, wherein the historic center value comprises:
a historic average ratio established based on a number of unhealthy resources and a number of total resources; or
an average absolute number of unhealthy resources.

20. The method of claim 18, wherein the first threshold and the second threshold are established based on a sensitivity input from an owner of the entity.
